(19) United States
(12) Patent Application Publication
(10) Pub. No.: US 2025/0244523 A1
(43) Pub. Date: Jul. 31, 2025

(54) Display device

(71) Applicant: Coretronic Corporation, Hsin-Chu (TW)

(72) Inventors: CHIN-YUAN CHANG, Hsin-Chu (TW); YIN-JEN LIN, Hsin-Chu (TW)

(21) Appl. No.: 19/008,659

(22) Filed: Jan. 3, 2025

(30) Foreign Application Priority Data
Jan. 31, 2024 (CN) 202410137113.X

(51) Int. Cl. F21V 8/00

(52) U.S. Cl. CPC G02B 6/0088

(57) ABSTRACT

A display device includes a back plate, a display panel, an elastic layer, a light guide plate, a cover plate and an adhesive layer. The display panel is opposite to an installing surface of the back plate. The elastic layer is compressed between the back plate and the display panel. The light guide plate is between the elastic layer and the adhesive layer. The adhesive layer is between the light guide plate and the cover plate, and includes a main body portion and an edge reinforcing portion surrounding the main body portion and connected to the light guide plate and the cover plate. The main body portion includes a first adhesive body disposed on the light guide plate and a second adhesive body stacked on the first adhesive body and the cover plate. An adhesion of the first adhesive body is different from an adhesion of the second adhesive body.

### CROSS-REFERENCE TO RELATED APPLICATION

This application claims the priority benefit of China application (No. 202410137113.X), filed on Jan. 31, 2024. The entirety of the above-mentioned patent application is hereby incorporated by reference herein and made a part of this specification.

### TECHNICAL FIELD

The disclosure relates to an image device, and more particularly to a display device.

### BACKGROUND

A conventional display device is generally provided with a display panel and a cover plate, etc. Particularly, the cover plate is usually disposed on the display panel, and the cover plate can be in a transparent manner to allow a beam of the display panel to be emitted. For example, the display device is also equipped with a light source module, the display panel is able to form an image through the beam emitted by the light source module, and a user is able to watch the image via the cover plate. On the other hand, a part of the display device can use ambient light as a light source, the cover plate can allow the ambient light to be incident to the display panel, and the display panel is able to form an image through the ambient light.

The conventional cover plate is usually bonded and fixed by adhesive bodies with different materials. However, since material properties of the materials of the adhesive bodies are different from each other, the adhesive bodies are easily partially detached from the cover plate or other object the adhesive bodies attached to with temperature changes. In this way, not only the cover plate easily falls off, but also external air easily penetrates into the adhesive body, which causes the image quality of the display device to be deteriorated.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure were acknowledged by a person of ordinary skill in the art.

### SUMMARY

In order to achieve one or a portion of or all of the objects or other objects, an embodiment of the present disclosure provides a display device including a back plate, a display panel, an elastic layer, a light guide plate, a cover plate and an adhesive layer. The back plate has an installing surface. The display panel is disposed opposite to the installing surface. The elastic layer is compressed between the back plate and the display panel. The light guide plate is disposed on a side of the display panel facing away from the elastic layer. The cover plate is disposed on a side of the light guide plate facing away from the display panel. The adhesive layer is disposed between the light guide plate and the cover plate, wherein the adhesive layer includes a main body portion and an edge reinforcing portion. The main body portion includes a first adhesive body and a second adhesive body stacked on the first adhesive body in a normal direction of the installing surface. The first adhesive body is disposed on the light guide plate, and the second adhesive body is connected to the first adhesive body and the cover plate. Adhesion of the first adhesive body is different from adhesion of the second adhesive body. The main body portion is surrounded by the edge reinforcing portion, and the edge reinforcing portion is connected to the light guide plate and the cover plate.

The display device of the present disclosure uses an adhesive layer to bond the light guide plate and the cover plate, and an elastic layer is disposed between the back plate and the display panel. Specifically, the cover plate is able to apply pressure to the display panel through the light guide plate and the adhesive layer so that the display panel and the back plate can compress the elastic layer. The compressed elastic layer is able to push against the light guide plate to be tightly against the adhesive layer via the display panel so that the adhesive layer is tightly sandwiched between the light guide plate and the cover plate. In addition, the edge reinforcing portion of the adhesive layer is able to enhance the bonding strength between the periphery of the light guide plate and the periphery of the cover plate to further prevent the periphery of the main body portion from detaching from the light guide plate. Based on the above, the display device of the present disclosure is able to make the cover plate and the light guide plate compress the adhesive layer tightly; in this way, not only the probability of the external air penetrating into the main body portion can be largely reduced but also the external air penetrating into the main body portion can be quickly squeezed out through the compressing force applied by the cover plate and the light guide plate to the main body portion. Therefore, the display device of the present disclosure is able to effectively improve the product yield and the image quality.

Other objectives, features and advantages of the present disclosure will be further understood from the further technological features disclosed by the embodiments of the present disclosure wherein there are shown and described preferred embodiments of this disclosure, simply by way of illustration of modes best suited to carry out the disclosure.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic cross-sectional diagram of a display device in an embodiment of the present disclosure;

FIG. 2 is a schematic cross-sectional diagram of the elements of the display device in FIG. 1 spaced apart from each other;

FIG. 3 is a schematic cross-sectional diagram of the display device in FIG. 1 where the cover plate has not yet been fixed to the end;

FIG. 4 is a schematic cross-sectional diagram of a display device where a cover plate has not been fixed to an end in another embodiment of the present disclosure;

FIG. 5 is a schematic cross-sectional diagram of the display device in FIG. 4 wherein the cover plate is fixed to the end;

FIG. 6 is a schematic cross-sectional diagram of a display device in another embodiment of the present disclosure;

FIG. 7 is a schematic top view diagram of the elastic layer in FIG. 6;

FIG. 8 is a schematic cross-sectional diagram of a display device in another embodiment of the present disclosure;

FIG. 9 is a schematic cross-sectional diagram of a display device in another embodiment of the present disclosure;

FIG. 10 is a schematic diagram of an orthographic projection of the first adhesive body on the light-emitting surface in FIG. 9; and

FIG. 11 is a schematic cross-sectional diagram of a display device in another embodiment of the present disclosure.

### DETAILED DESCRIPTION OF PREFERRED EMBODIMENTS

In the following detailed description of the preferred embodiments, reference is made to the accompanying drawings which form a part hereof, and in which are shown by way of illustration specific embodiments in which the disclosure may be practiced. In this regard, directional terminology, such as “top,” “bottom,” “front,” “back,” etc., is used with reference to the orientation of the Figure(s) being described. The components of the present disclosure can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present disclosure. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

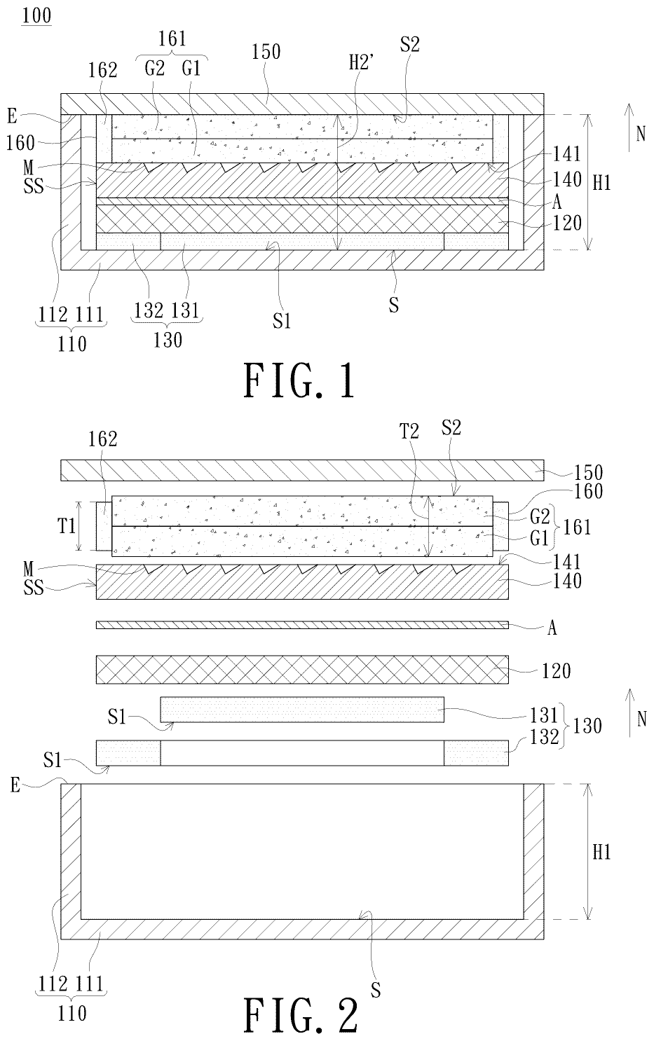

FIG. 1 is a schematic cross-sectional diagram of a display device in an embodiment of the present disclosure. FIG. 2 is a schematic cross-sectional diagram of the elements of the display device in FIG. 1 spaced apart from each other. Referring to FIGS. 1 and 2, a display device 100 includes a back plate 110, a display panel 120, an elastic layer 130, a light guide plate 140, a cover plate 150, and an adhesive layer 160. The back plate 110 has an installing surface S. The display panel 120 is disposed opposite to the installing surface S. The elastic layer 130 is compressed between the back plate 110 and the display panel 120. The light guide plate 140 is disposed on a side of the display panel 120 facing away from the elastic layer 130. The cover plate 150 is disposed on a side of the light guide plate 140 facing away from the display panel 120. The adhesive layer 160 is disposed between the light guide plate 140 and the cover plate 150, wherein the adhesive layer 160 includes a main body portion 161 and an edge reinforcing portion 162. The main body portion 161 includes a first adhesive body G1 and a second adhesive body G2 stacked on the first adhesive body G1 in a normal direction N of the installing surface S. The first adhesive body G1 is disposed on the light guide plate 140, and the second adhesive body G2 is connected to the first adhesive body G1 and the cover plate 150. The adhesion of the first adhesive body G1 is different from the adhesion of the second adhesive body G2. The main body portion 161 is surrounded by the edge reinforcing portion 162, and the edge reinforcing portion 162 is connected to the light guide plate 140 and the cover plate 150.

The cover plate 150 is a transparent cover plate to allow light to pass therethrough. For example, the material of the cover plate 150 may include glass, plastic and other light-transmitting material, but the disclosure is not limited thereto.

In this embodiment, the main body portion 161 of the adhesive layer 160 may adhere to the light guide plate 140 and the cover plate 150. Particularly, the main body portion 161 uses the first adhesive body G1 and the second adhesive body G2 with different adhesion, and therefore, the volume change of the first adhesive body G1 may be different from the volume change of the second adhesive body G2 when the temperature of the main body portion 161 changes, thereby causing the first adhesive body G1 to be partially detached from the light guide plate 140. In this way, the external air can easily penetrate into the gap between the first adhesive body G1 and the light guide plate 140 to affect the image quality of the display device 100. For example, in the prior art, the first adhesive body is prone to detach from the light guide plate from the edge, which causes the external air to penetrate into the gap between the first adhesive body and the light guide plate, and the external air is squeezed by the first adhesive body and gradually moves to the middle area of the gap. Thus, the external air remains between the first adhesive body and the light guide plate and cannot be discharged.

The adhesive layer 160 in this embodiment further uses the edge reinforcing portion 162, wherein the edge (end edge) of the main body portion 161 can be covered by the edge reinforcing portion 162, and the main body portion 161 can be clamped more tightly by the light guide plate 140 and the cover plate 150 via the edge reinforcing portion 162. Therefore, the edge reinforcing portion 162 is able to significantly reduce the probability of the external air penetrating into the main body portion 161.

The main body portion 161 in this embodiment can be transparent to allow light to pass therethrough. The material of the first adhesive body G1 is, for example, different from the material of the second adhesive body G2, so that the first adhesive body G1 and the second adhesive body G2 have different adhesion. For example, the material of the first adhesive body G1 may include polyurethane, organic silicon, or acrylic resin, and the material of the second adhesive body G2 may include unsaturated polyester, epoxy resin, or acrylic resin. In one embodiment, the adhesion of the first adhesive body G1 can be less than the adhesion of the second adhesive body G2, and the adhesion of the first adhesive body G1 is, for example, less than or equal to 500 mN/25 mm. However, the specific numerical value of adhesion is not limited by the present disclosure.

The edge reinforcing portion 162 in this embodiment includes, for example, a double-sided tape, and the push-out resistance of the double-sided tape may be larger than or equal to 200 N. For example, it requires applying a pushing force above 200 N on the cover plate 150 along the normal direction N to separate the cover plate 150 from the edge reinforcing portion 162. Therefore, the main body portion 161 can be clamped more tightly by the light guide plate 140 and the cover plate 150 via the edge reinforcing portion 162 to further reduce the probability of the external air penetrating into the main body portion 161. Incidentally, the push-out resistance may be changed by adjusting the compounds of the glue of the double-sided tape, and the detailed feature of the double-sided tape is not limited by the present disclosure. It is worth mentioning that the thickness T1 of the edge reinforcing portion 162 in the normal direction N is, for example, less than the thickness T2 of the main body portion 161 in the normal direction N in this embodiment. The thicknesses T1 and T2 are both marked in FIG. 2, the thickness T1 is the thickness of the edge reinforcing portion 162 without being compressed and deformed, and the thickness T2 is the thickness of the main body portion 161 without being compressed and deformed. In this way, the edge reinforcing portion 162 can further tighten the light guide plate 140 and the cover plate 150 to clamp the main body portion 161 more tightly, thereby further reducing the probability of the external air penetrating into the main body portion 161. It can be understood that the second adhesive body G2 is more prone to deformation than the first adhesive body G1 after the first adhesive body G1 and the second adhesive body G2 are compressed by the light guide plate 140 and the cover plate 150. For example, the hardness of the first adhesive body G1 and the hardness of the second adhesive body G2 each can be less than the hardness of the edge reinforcing portion 162. Therefore, when the thickness T1 of the edge reinforcing portion 162 is less than the thickness T2 of the main body portion 161, the light guide plate 140 and the cover plate 150 can be tightened by the contracting force of the edge reinforcing portion 162 to effectively compress the main body portion 161, thereby clamping the main body portion 161 more tightly. For example, the material of the main body portion 161 may include an optical clear adhesive (OCA), and the edge reinforcing portion 162 may include a double-sided tape, wherein the optical clear adhesive is more prone to deformation than the double-sided tape after the optical clear adhesive and the double-sided tape are compressed by the light guide plate 140 and the cover plate 150.

In this embodiment, the light-emitting surface 141 of the light guide plate 140 faces the cover plate 150, and the adhesive layer 160 can be disposed on the light-emitting surface 141. Particularly, the first adhesive body G1 can be disposed on the light-emitting surface 141, and the second adhesive body G2 can be disposed between the first adhesive body G1 and the cover plate 150. In addition, the light-emitting surface 141 has, for example, a plurality of microstructures M, wherein the microstructures M can be in a manner of concave structure, but other embodiments are not limited thereto. The detailed features of the microstructures M are described in the following paragraphs.

The display panel 120 in this embodiment includes, for example, a reflective display panel. For example, the ambient light can be incident on the reflective display panel through the cover plate 150, the adhesive layer 160, and the light guide plate 140, and the reflective display panel is able to form an image through the ambient light. In addition, a light-emitting element may be disposed on the side surface SS of the light guide plate 140, and the light-emitting element is able to provide a light beam to the display panel 120 when the ambient light is insufficient. Incidentally, the display panel 120 can be fixed to a side of the light guide plate 140 opposite to the light-emitting surface 141 via the light-transmitting adhesive layer A, wherein the light-transmitting adhesive layer A includes, for example, the optical clear adhesive, but the present disclosure is not limited thereto.

The elastic layer 130 in this embodiment can be disposed on the installing surface S, and the elastic layer 130 can be compressed between the installing surface S and the display panel 120. The elastic layer 130 can be deformed after being compressed by the back plate 110 and the display panel 120, thereby the elastic layer 130 applying back a pushing force to the display panel 120. In this way, the elastic layer 130 is able to push against the light guide plate 140 toward the cover plate 150 through the display panel 120, so that the adhesive layer 160 is tightly clamped by the light guide plate 140 and the cover plate 150, thereby more quickly squeezing out the air penetrating into the main body portion 161. For example, the conventional display device often fails to reduce the volume of the penetrating air even though a conventional display device is left standing for more than one day. However, the display device 100 in an embodiment of the present disclosure can significantly reduce the volume of the penetrating air after being left standing for about 2 to 4 hours. The material of the elastic layer 130 may include sponge or foam, but the disclosure is not limited thereto. In this embodiment, the elastic layer 130 can include the central portion 131 and the peripheral portion 132. The central portion 131 is surrounded by the peripheral portion 132, and the peripheral portion 132 overlaps with the edge reinforcing portion 162 in the normal direction N. Furthermore, the central portion 131 is able to push against the main body portion 161, and the peripheral portion 132 is able to push against the edge reinforcing portion 162 and a part of the main body portion 161. Moreover, the hardness of the peripheral portion 132 is, for example, larger than the hardness of the central portion 131. In this way, the peripheral portion 132 is able to apply back a larger pushing force to the light guide plate 140 and the edge reinforcing portion 162 through the display panel 120, so that the edge reinforcing portion 162 is more tightly sealed between the light guide plate 140 and the cover plate 150. In one embodiment, the material of the peripheral portion 132 may be different from the material of the central portion 131, so that the hardness of the peripheral portion 132 is different from the hardness of the central portion 131. For example, the materials of the peripheral portion 132 and the central portion 131 each may include sponges with different densities, wherein the types of sponges may include PORON, EPDM (Ethylene Propylene Diene Monomer), CR (Chloroprene) or EVA (Ethylene-Vinyl acetate copolymer), which are not limited by the present disclosure.

In this embodiment, the back plate 110 may have a bottom plate portion 111 and a side wall portion 112. The installing surface S is located at the bottom plate portion 111, and the side wall portion 112 stands on the installing surface S. Specifically, the display panel 120 is disposed opposite to the bottom plate portion 111, and the elastic layer 130 can be compressed between the display panel 120 and the bottom plate portion 111. In addition, the display panel 120, the elastic layer 130, and the adhesive layer 160 can be surrounded by the side wall portion 112, and the cover plate 150 can be disposed on the side wall portion 112.

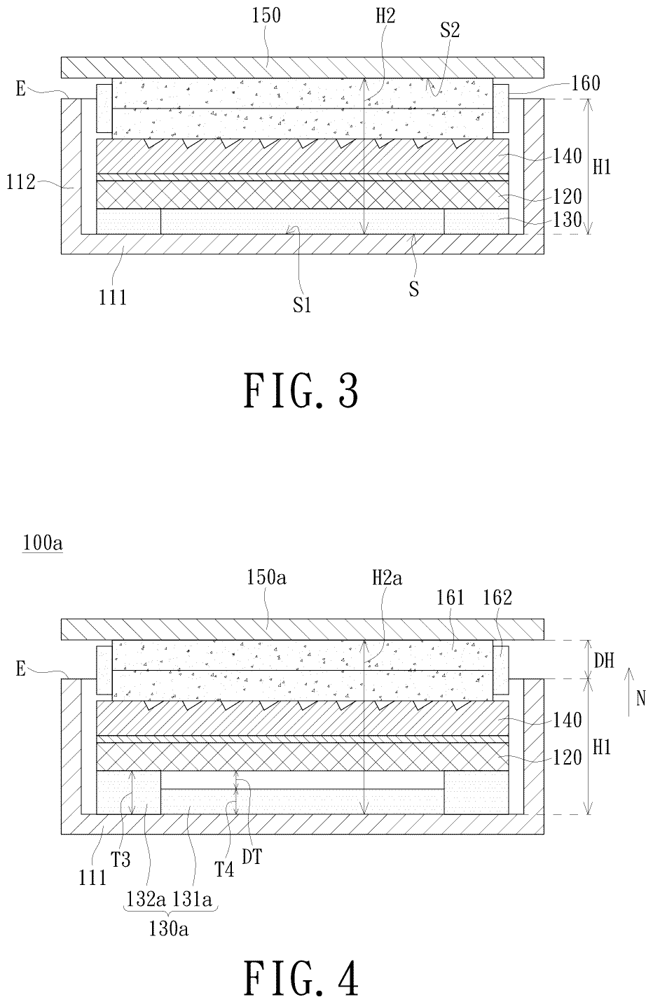

FIG. 3 is a schematic cross-sectional diagram of the display device in FIG. 1 where the cover plate has not yet been fixed to the end. Further, referring to FIGS. 1 and 3, the elastic layer 130 has a first surface S1 (also marked in FIG. 2) facing the installing surface S. For example, in this embodiment, the surface of the central portion 131 and the surface of the peripheral portion 132 both facing the installing surface S may be substantially coplanar to form the first surface S1. The main body portion 161 has the second surface S2 (also marked in FIG. 2) facing the cover plate 150. The side wall portion 112 has the end E facing away from the installing surface S. The cover plate 150 is disposed at the end E and pressed against the second surface S2, wherein the second surface S2 includes, for example, a surface of the second adhesive body G2 attached to the cover plate 150. The first height H1 between the installing surface S and the end E is less than the second height H2 between the first surface S1 and the second surface S2. It should be noted that the second height H2 can be the height between the first surface S1 and the second surface S2 when the elastic layer 130 and the adhesive layer 160 are not compressed. Therefore, as shown in FIG. 1, the cover plate 150 is able to push against the adhesive layer 160 and the light guide plate 140 to compress the display panel 120 harder after the cover plate 150 is fixed to the end E, so that the display panel 120 and the bottom plate portion 111 more tightly clamp the elastic layer 130, thereby making the elastic layer 130 push back to the light guide plate 140 with a larger pushing force through the display panel 120. Based on the above, the light guide plate 140 and the cover plate 150 can more tightly clamp the adhesive layer 160, thereby further reducing the probability of the external air penetrating into the main body portion 161, and also more quickly squeezing out the external air penetrating into the main body portion 161. Incidentally, because the elastic layer 130 is compressed after the cover plate 150 is fixed to the end E, the second height H2′ between the first surface S1 and the second surface S2 is slightly less than the second height H2 in FIG. 3, and the second height H2′ may be approximately the same as the first height H1. In addition, the installing surface S, the first surface S1 and the second surface S2 may be substantially parallel to each other, but other embodiments are not limited to this.

Compared with the prior art, the display device 100 in this embodiment uses the adhesive layer 160 to bond the light guide plate 140 and the cover plate 150, and the elastic layer 130 is disposed between the back plate 110 and the display panel 120. Specifically, the cover plate 150 is able to apply pressure to the display panel 120 through the light guide plate 140 and the adhesive layer 160 so that the display panel 120 and the back plate 110 can compress the elastic layer 130. The compressed elastic layer 130 is able to push against the light guide plate 140 to be tightly against the adhesive layer 160 through the display panel 120, so that the adhesive layer 160 is tightly sandwiched between the light guide plate 140 and the cover plate 150. In addition, the edge reinforcing portion 162 of the adhesive layer 160 is able to enhance the bonding strength between the periphery of the light guide plate 140 and the periphery of the cover plate 150 to further prevent the periphery of the main body portion 161 from detaching from the light guide plate 140. Based on the above, the display device 100 in this embodiment is able to make the cover plate 150 and the light guide plate 140 tightly compress the adhesive layer 160; in this way, not only the probability of the external air penetrating into the main body portion 161 can be largely reduced, but also the external air penetrating into the main body portion 161 can be quickly squeezed out through the compressing force applied to the main body portion 161 by the cover plate 150 and the light guide plate 140. Therefore, the display device 100 in this embodiment is able to effectively improve the product yield and the image quality.

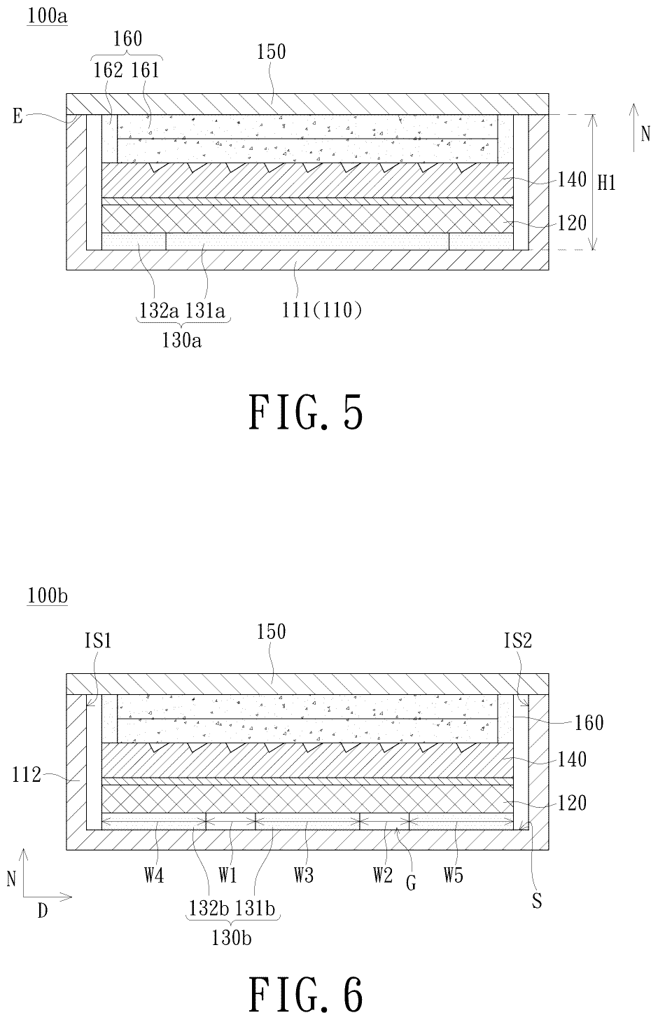

FIG. 4 is a schematic cross-sectional diagram of a display device where a cover plate has not been fixed to an end in another embodiment of the present disclosure. FIG. 5 is a schematic cross-sectional diagram of the display device in FIG. 4 wherein the cover plate is fixed to the end. The structure and advantages of a display device 100a in this embodiment are similar to those of the embodiment in FIG. 1, and only the differences are described below. Referring to FIGS. 4 and 5, for an elastic layer 130a in this embodiment, a thickness T3 of a peripheral portion 132a in the normal direction N can be larger than a thickness T4 of a central portion 131a in the normal direction N, wherein the thickness T3 can be the thickness when the peripheral portion 132a has not been compressed, and the thickness T4 can be the thickness when the central portion 131a has not been compressed. Thus, the pushing force applied to the edge reinforcing portion 162 by the peripheral portion 132a can be further enhanced, so that the edge reinforcing portion 162 is able to more tightly seal the main body portion 161. Particularly, the amount of compression of the peripheral portion 132a made by the display panel 120 and the bottom plate portion 111 is larger than that of the central portion 131a after the cover plate 150 is fixed to the end E. In this way, the peripheral portion 132a is able to push back to the light guide plate 140 with a larger pushing force through the display panel 120, so that the light guide plate 140 and the cover plate 150 more tightly clamp the edge reinforcing portion 162. Furthermore, there is a thickness difference DT in the normal direction N between the central portion 131a and the peripheral portion 132a both uncompressed when the cover plate 150 has not been fixed to the end E, wherein the thickness difference DT=T3−T4. There is a height difference DH (marked in FIG. 4) in the normal direction N between the first height H1 and the second height H2a, wherein the height difference DH=H2a−H1. An absolute value of the height difference DH can be larger than an absolute value of the thickness difference DT. Hence, the amount of the compression of the peripheral portion 132a made by the display panel 120 and the bottom plate portion 111 can be further enhanced when the cover plate 150 is fixed to the end E, so that the peripheral portion 132a is able to push back to the light guide plate 140 with a pushing force through the display panel 120, which makes the light guide plate 140 and the cover plate 150 more tightly clamp the main body portion 161. It can be understood that the thickness difference DT shown in FIG. 4 may be approximate to zero after the cover plate 150 is fixed to the end E. Incidentally, the definition of the second height H2a is the same as that of the second height H2 in FIG. 3, so the relevant description is omitted here.

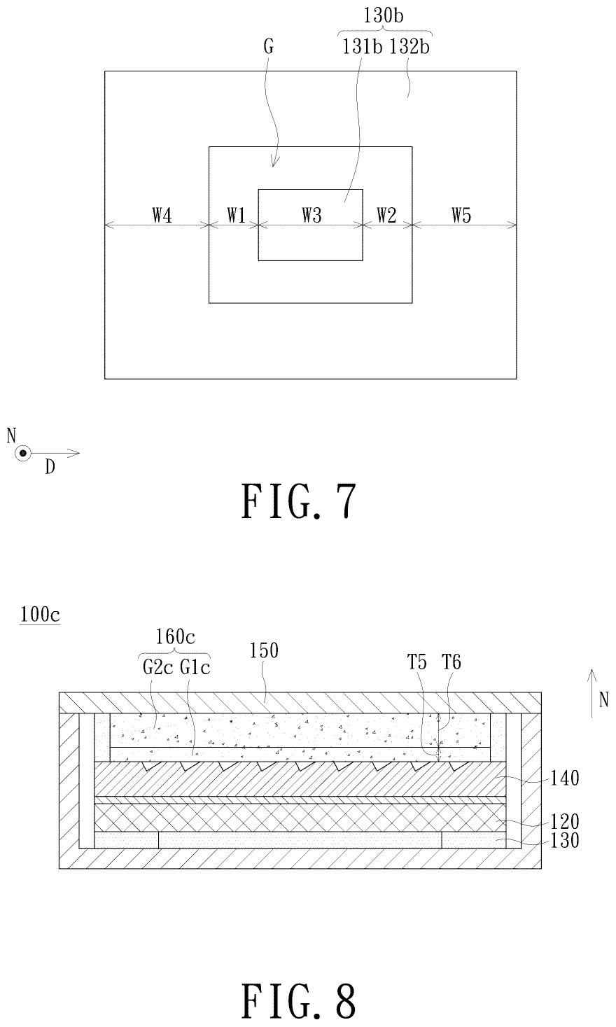

FIG. 6 is a schematic cross-sectional diagram of a display device in another embodiment of the present disclosure. FIG. 7 is a schematic top view diagram of the elastic layer in FIG. 6. The structure and advantages of a display device 100b in this embodiment are similar to those of the embodiment in FIG. 1, and only the differences are described below. Referring to FIGS. 6 and 7, the peripheral portion 132b and the central portion 131b of the elastic layer 130b are, for example, spaced apart from each other; that is, there is a gap G between the peripheral portion 132b and the central portion 131b, so the display panel 120 is able to apply the pressure to the elastic layer 130b more evenly. Particularly, the hardness of the peripheral portion 132b may be different from the hardness of the central portion 131b, so there may be a difference of deformation between deformation of the peripheral portion 132b and deformation of the central portion 131b after the elastic layer 130b is compressed. However, in this embodiment, the difference of deformation can be progressively changed from the peripheral portion 132b to the central portion 131b through the gap G, so this can prevent the pressure applied to the elastic layer 130b by the display panel 120 from being too concentrated on the junction of the peripheral portion 132b and the central portion 131b. Similarly, in an embodiment, a thickness of the peripheral portion 132b in the normal direction N may be different from a thickness of the central portion 131b in the normal direction N when the elastic layer 130b has not been compressed. Thus, there may be a difference of deformation between the peripheral portion 132b and the central portion 131b after being compressed, and the display panel 120 is still able to evenly apply the pressure to the elastic layer 130b through spacing the peripheral portion 132b apart from the central portion 131b. Incidentally, in this embodiment, widths W1 and W2 of the gap G in the direction D may be equal to each other. Further, the direction D may be directed to an inner surface IS2 from an inner surface IS1 of the side wall portion 112, wherein the inner surfaces IS1 and IS2 are opposite to each other and both stand on the installing surface S, and the display panel 120, the elastic layer 130b, the light guide plate 140, and the adhesive layer 160 are all located between the inner surfaces IS1 and IS2. In an embodiment, the gap G may be more than 10 mm, but the present disclosure is not limited thereto. In addition, in this embodiment, a width W3 of the central portion 131b and widths W4 and W5 of the peripheral portion 132b both in the direction D may be equal to each other.

FIG. 8 is a schematic cross-sectional diagram of a display device in another embodiment of the present disclosure. The structure and advantages of the display device 100c in this embodiment are similar to those of the embodiment in FIG. 1, and only the differences are described below. Referring to FIG. 8, the material of the first adhesive body G1c and the material of the second adhesive body G2c of the adhesive layer 160c are the same, and the thickness T5 of the first adhesive body G1c in the normal direction N can be different from the thickness T6 of the second adhesive body G2c in the normal direction N, so the first adhesive body G1c and the second adhesive body G2c have different adhesion. For example, the thickness T5 of the first adhesive body G1c may be less than the thickness T6 of the second adhesive body G2c; in this way, the adhesion of the first adhesive body G1c is less than the adhesion of the second adhesive body G2c.

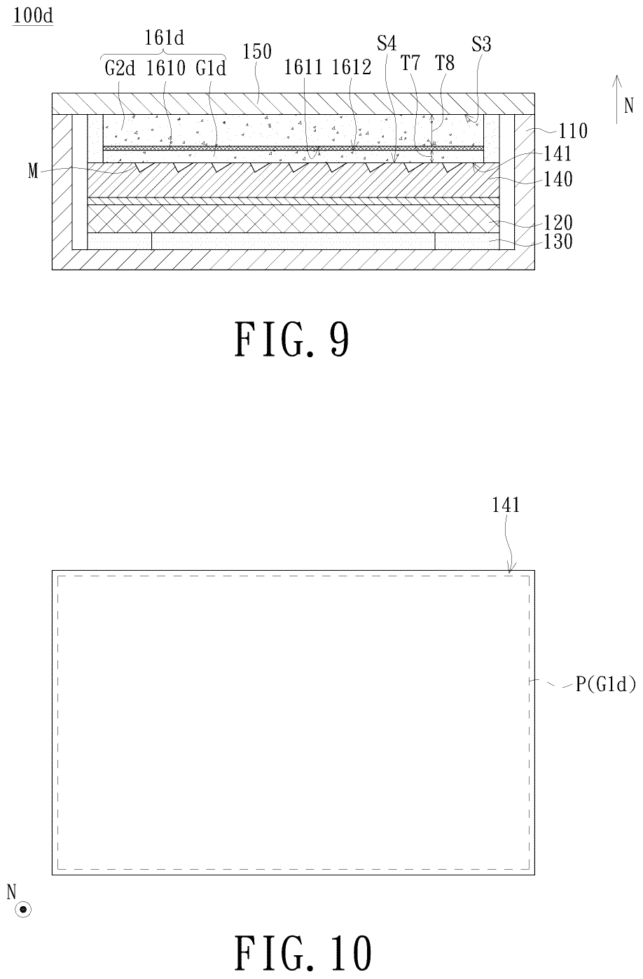

FIG. 9 is a schematic cross-sectional diagram of a display device in another embodiment of the present disclosure. The structure and advantages of a display device 100d in this embodiment are similar to those of the embodiment of FIG. 1, and only the differences are described below. Referring to FIG. 9, the main body portion 161d can further include the optical film 1610. The optical film 1610 is sandwiched between the first adhesive body G1d and the second adhesive body G2d, and the thickness T7 of the first adhesive body G1d is less than the thickness T8 of the second adhesive body G2d, wherein the thicknesses T7 and T8 are respectively the thicknesses of the first adhesive body G1d and the second adhesive body G2d both in the normal direction N. Specifically, the light-emitting surface 141 has recessed microstructures M, and the first adhesive body G1d is directly in contact with the light-emitting surface 141, and therefore, the first adhesive body G1d may have the smaller thickness T7 than that of the second adhesive body G2d, so as to reduce the amount of the first adhesive body G1d flowing into the microstructures M before curing, thereby further improving the image quality of the display device 100d. Furthermore, the adhesion of the first adhesive body G1d is, for example, less than the adhesion of the second adhesive body G2d, and in an embodiment, the thickness T7 of the first adhesive body G1d may be less than 50 μm, so as to further reduce the amount of the first adhesive body G1d flowing into the microstructures M.

In this embodiment, the hardness of the optical film 1610 may be larger than the hardness of the first adhesive body G1d and the hardness of the second adhesive body G2d. For example, a material of the optical film 1610 may include polyethylene terephthalate (PET), Triacetate Cellulose Film (TAC), Polycarbonate (PC) or Polymethyl methacrylate (PMMA). In this way, the first adhesive body G1d can be more difficult to flow into the microstructures M via being supported by the optical film 1610, thereby further improving the image quality of the display device 100d. The optical film 1610 includes, for example, a polarizer, and in one embodiment, the optical film 1610 may include a transparent film without additional optical functions.

The main body portion 161d in this embodiment has surfaces

S3 and S4. The surfaces S3 and S4 are opposite to each other, the surface S4 faces the light guide plate 140, and the surface S3 faces the cover plate 150. It should be noted that the surface S3 facing the cover plate 150 is the second surface S2 shown in FIG. 1. The surfaces S3 and S4 each include, for example, a flat surface. Specifically, the surfaces S3 and S4 do not have an optical structure with a size being approximate to the microstructure M. For example, surfaces 1611 and 1612 of the optical film 1610 are not provided with an optical structure with a size approximate to the microstructure M, so that the surfaces S3 and S4 of the main body portion 161d are able to keep being flat. The surfaces S3 and S4 in this embodiment may be substantially parallel to the light-emitting surface 141, and in an embodiment, the surfaces S3 and S4 may each have an included angle being less than 5 degrees with the light-emitting surface 141.

FIG. 10 is a schematic diagram of an orthographic projection of the first adhesive body on the light-emitting surface in FIG. 9. Referring to FIGS. 9 and 10, incidentally, a ratio of a projecting area of the first adhesive body G1d on the light-emitting surface 141 to an area of the light-emitting surface 141 can be larger than 0.8, wherein the projecting area may be an area of an orthographic projection P of the first adhesive body G1d on the light-emitting surface 141. Particularly, the first adhesive body G1d may be disposed on the light-emitting surface 141 through a manner of direct bonding. In this way, the gap between the light-emitting surface 141 and the optical film 1610 can be fully filled by the first adhesive body G1d, thereby reducing reflection at the interface when light passes through a main body portion 161d. Incidentally, in this embodiment, the ratio is approximate to 1, and FIG. 10 shows the area of the orthographic projection P of the first adhesive body G1d as slightly less than the area of the light-emitting surface 141, so as to clearly show the orthographic projection P of the first adhesive body G1d.

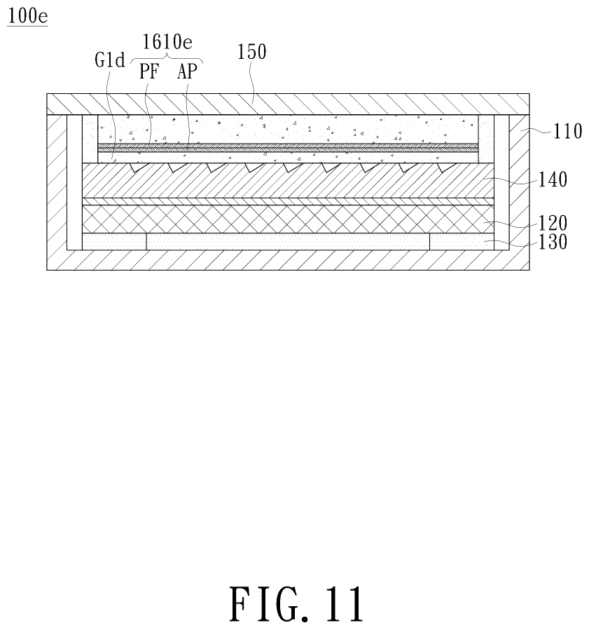

FIG. 11 is a schematic cross-sectional diagram of a display device in another embodiment of the present disclosure. The structure and advantages of a display device 100e in this embodiment are similar to those of the embodiment in FIG. 9, and only the differences are described below. Referring to FIG. 11, in addition to the polarizer PF, an optical film 1610e can further include a dual brightness enhancement film AP, and the dual brightness enhancement film AP is disposed between the first adhesive body G1d and the polarizer PF to improve image contrast of the display device 100e. Specifically, the transmission axis of the polarizer PF and the transmission axis of the dual brightness enhancement film AP are, for example, substantially parallel to each other, and the polarization angle between a light beam after passing through the polarizer PF and after passing through the dual brightness enhancement film AP may be less than 20 degrees. However, these details are not limited by the present disclosure.

In summary, the display device of the present disclosure uses an adhesive layer to bond the light guide plate and the cover plate, and an elastic layer is disposed between the back plate and the display panel. Specifically, the cover plate is able to apply pressure to the display panel through the light guide plate and the adhesive layer so that the display panel and the back plate can compress the elastic layer. The compressed elastic layer is able to push against the light guide plate to be tightly against the adhesive layer through the display panel so that the adhesive layer is tightly sandwiched between the light guide plate and the cover plate. In addition, the edge reinforcing portion of the adhesive layer is able to enhance the bonding strength between the periphery of the light guide plate and the periphery of the cover plate to further prevent the periphery of the main body portion from detaching from the light guide plate. Based on the above, the display device of the present disclosure is able to make the cover plate and the light guide plate compress the adhesive layer tightly; in this way, not only the probability of the external air penetrating into the main body portion can be largely reduced but also the external air penetrating into the main body portion can be quickly squeezed out through the compressing force applied by the cover plate and the light guide plate to the main body portion. Therefore, the display device of the present disclosure is able to effectively improve the product yield and the image quality.

The foregoing description of the preferred embodiments of the disclosure has been presented for purposes of illustration and description. It is not intended to be exhaustive or to limit the disclosure to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the disclosure and its best mode practical application, thereby to enable persons skilled in the art to understand the disclosure for various embodiments and with various modifications as are suited to the particular use or implementation contemplated. It is intended that the scope of the disclosure be defined by the claims appended hereto and their equivalents in which all terms are meant in their broadest reasonable sense unless otherwise indicated. Therefore, the term “the disclosure”, “the present disclosure” or the like does not necessarily limit the claim scope to a specific embodiment, and the reference to particularly preferred exemplary embodiments of the disclosure does not imply a limitation on the disclosure, and no such limitation is to be inferred. The disclosure is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the disclosure. It should be appreciated that variations may be made in the embodiments described by persons skilled in the art without departing from the scope of the present disclosure as defined by the following claims. Moreover, no element and component in the present disclosure is intended to be dedicated to the public regardless of whether the element or component is explicitly recited in the following claims.

What is claimed is:

1. A display device, comprising:
a back plate, having an installing surface;
a display panel, disposed opposite to the installing surface;
an elastic layer, compressed between the back plate and the display panel;
a light guide plate, disposed on a side of the display panel facing away from the elastic layer;
a cover plate, disposed on a side of the light guide plate facing away from the display panel; and
an adhesive layer, disposed between the light guide plate and the cover plate, wherein the adhesive layer comprises a main body portion and an edge reinforcing portion, the main body portion comprises a first adhesive body and a second adhesive body stacked on the first adhesive body in a normal direction of the installing surface, the first adhesive body is disposed on the light guide plate, the second adhesive body is connected to the first adhesive body and the cover plate, adhesion of the first adhesive body is different from adhesion of the second adhesive body, the main body portion is surrounded by the edge reinforcing portion, and the edge reinforcing portion is connected to the light guide plate and the cover plate.

2. The display device according to claim 1, wherein the elastic layer comprises a central portion and a peripheral portion, the central portion is surrounded by the peripheral portion, and the peripheral portion overlaps with the edge reinforcing portion in the normal direction.

3. The display device according to claim 2, wherein hardness of the peripheral portion is larger than hardness of the central portion.

4. The display device according to claim 2, wherein a thickness of the peripheral portion in the normal direction is larger than a thickness of the central portion in the normal direction.

5. The display device according to claim 2, wherein a material of the peripheral portion is different from a material of the central portion.

6. The display device according to claim 2, wherein the peripheral portion and the central portion are spaced apart from each other.

7. The display device according to claim 2, wherein the back plate has a bottom plate portion and a side wall portion, the installing surface is located at the bottom plate portion, the elastic layer is disposed on the installing surface and has a first surface facing the installing surface, the main body portion has a second surface facing the cover plate, the side wall portion stands on the installing surface and has an end facing away from the installing surface, the cover plate is disposed at the end and is pressed against the second surface, a first height between the installing surface and the end is less than a second height between the first surface and the second surface.

8. The display device according to claim 7, wherein a thickness of the peripheral portion is larger than a thickness of the central portion, there is a thickness difference between the central portion and the peripheral portion in the normal direction, there is a height difference between the first height and the second height in the normal direction, and an absolute value of the height difference is larger than an absolute value of the thickness difference.

9. The display device according to claim 1, wherein a material of the elastic layer comprises sponge or foam.

10. The display device according to claim 1, wherein the edge reinforcing portion comprises a double-sided tape, and push-out resistance of the double-sided tape is larger than or equal to 200 N.

11. The display device according to claim 1, wherein hardness of the first adhesive body and hardness of the second adhesive body each are less than hardness of the edge reinforcing portion, and a thickness of the edge reinforcing portion in the normal direction is less than a thickness of the main body portion in the normal direction.

12. The display device according to claim 1, wherein a thickness of the edge reinforcing portion in the normal direction is less than a thickness of the main body portion in the normal direction.

13. The display device according to claim 1, wherein a material of the first adhesive body and a material of the second adhesive body are different from each other.

14. The display device according to claim 1, wherein a material of the first adhesive body is the same as a material of the second adhesive body, and a thickness of the first adhesive body in the normal direction is different from a thickness of the second adhesive body in the normal direction.

15. The display device according to claim 14, wherein the light guide plate has a light-emitting surface, the first adhesive body is disposed on the light-emitting surface, the light-emitting surface has a plurality of microstructures, the main body portion further comprises an optical film, the optical film is sandwiched between the first adhesive body and the second adhesive body, and the thickness of the first adhesive body is less than the thickness of the second adhesive body.

16. The display device according to claim 15, wherein the adhesion of the first adhesive body is less than the adhesion of the second adhesive body, and the thickness of the first adhesive body is less than 50 μm.

17. The display device according to claim 15, wherein a material of the optical film comprises polyethylene terephthalate, triacetate cellulose film, polycarbonate or polymethyl methacrylate.

18. The display device according to claim 15, wherein the optical film comprises a polarizer.

19. The display device according to claim 18, wherein the optical film further comprises a dual brightness enhancement film, and the dual brightness enhancement film is disposed between the first adhesive body and the polarizer.

20. The display device according to claim 15, wherein the main body portion has two surfaces, the two surfaces are opposite to each other and respectively face the cover plate and the light guide plate, and the two surfaces each comprise a flat surface.

21. The display device according to claim 15, wherein a ratio of a projecting area of the first adhesive body on the light-emitting surface to an area of the light-emitting surface is larger than 0.8.
